(19) United States
(12) Patent Application Publication
(10) Pub. No.: US 2004/0212589 A1
(43) Pub. Date: Oct. 28, 2004

(54) System and method for fusing and displaying multiple degree of freedom positional input data from multiple input sources

(76) Inventors: Deirdre M. Hall, Beverly, MA (US); Rick K. Dorval, Goffstown, NH (US); Won Chun, Cambridge, MA (US); Gregg E. Favalora, Cambridge, MA (US); Joshua Napoli, Lexington, MA (US)

Correspondence Address: CANTOR COLBURN LLP, 55 Griffin Road South, Bloomfield, CT, 06002, US

(21) Appl. No.: 10/828,405

(22) Filed: Apr. 19, 2004

Related U.S. Application Data
(60) Provisional application No. 60/465,065, filed on Apr. 24, 2003.

(51) Int. Cl. G09G 5/00

(52) U.S. Cl. 345/156

(57) ABSTRACT

A system for fusing multiple degree of freedom (DOF) positional input data includes software configured to scale positional output data from a first positional input device and a second positional input device, using a common axis therebetween. The positional output data from the first positional input device has at least two degrees of freedom associated therewith, and the positional output data from the second positional input device has at least two degrees of freedom associated therewith.

### CROSS REFERENCE TO RELATED APPLICATIONS

This application claims the benefit of U.S. provisional application No. 60/465,065, filed Apr. 24, 2003, the contents of which are incorporated by reference herein in their entirety.

### BACKGROUND

The present invention relates generally to human-computer interfaces (HCIs) and, more particularly, to a system and method for fusing and displaying multiple degree-of-freedom (DOF) positional input data from multiple input sources.

Presently, a broad class of computer software (in addition to newly emergent three-dimensional (3-D) displays) utilizes input from users that have three or more degrees-of-freedom associated therewith. For example, mechanical computer-aided design (MCAD) software such as Pro/ENGINEER® (by Parametric Technologies Corp.) and SolidWorks® (by Dassault Systèmes) allows a user to construct 3-D product designs, and would therefore benefit from true 3-D input devices rather than a device such as a conventional 2-D mouse. In addition, chemists performing pharmaceutical design often need to gesture at certain regions within complex molecules, such as simulated in the software package DS ViewerPro (by Accelrys). In this regard, the most natural gesture would be a physical “pointing” or similar hand waving motion in the space near the computer display.

Currently, there are several commercially available, multidimensional HCIs. For example, the SpaceBall® 5000 motion controller (available from Logitech/3D Connexion) is a device that may be translated and rotated in six degrees-of-freedom (6DOF). Also, the Phantom® Haptic interface/force-feedback peripheral device (available from SensAble Technologies) allows for the exploration of application areas requiring force feedback in 6DOF, such as virtual assembly, virtual prototyping, maintenance path planning, teleoperation and molecular modeling.

However, existing 3-D input devices such as those described above have at least one or more drawbacks associated therewith. First, they tend to be “non-parkable.” In other words, it is desirable to be able to halt (for example) the position of a 3-D mouse pointer once the user relaxes his arm. Typically, a device such as a joystick is one that is biased to return to a center position when released by the user. Thus, a non-parkable device is one that will nonetheless continue to track undesirable user motion. Second, the existing 3-D input systems are expensive, and in some cases require elaborate position tracking hardware in acoustically or electrically shielded environments. Third, such devices may also have a limited physical range of motion, thus translating in a limited range of motion of the cursor or displayed object. Fourth, there is a lack of flexibility with regard to the ability to arbitrarily map user motion and rotation (such as detected by a hand-operated input device, for example) into human-computer input data.

Accordingly, it would be desirable to have a 3-D input system/device that is relatively inexpensive, that is “parkable” (i.e., that remains in its last location), flexible, scalable and capable of large dynamic range, among other aspects.

### SUMMARY

The foregoing discussed drawbacks and deficiencies of the prior art are overcome or alleviated by a system for fusing multiple degree of freedom (DOF) positional input data. In an exemplary embodiment, the system includes software configured to scale positional output data from a first positional input device and a second positional input device, using a common axis therebetween. The positional output data from the first positional input device has at least two degrees of freedom associated therewith, and the positional output data from the second positional input device has at least two degrees of freedom associated therewith.

In another embodiment, a system for fusing and displaying multiple degree of freedom (DOF) positional input data includes a first positional input device, a second positional input device configured to track the position of the first positional input device, and software in communication with the first and the second positional input device. The software is configured to scale positional output data from the first and the second positional input devices using a common axis therebetween. A three dimensional display is configured to display scaled positional output data from the software.

In still another embodiment, a method for fusing and displaying multiple DOF positional input data from multiple input sources includes receiving positional input data from a first positional input device, receiving positional input data from a second positional input device, and scaling the positional input data from the first and said second positional input devices using a common axis therebetween. Scaled positional output data is displayed on a three dimensional display device.

In another embodiment, a storage medium includes a machine readable computer program code for fusing and displaying multiple degree of freedom (DOF) positional input data from multiple input sources, and instructions for causing a computer to implement a method. The method includes receiving positional input data from a first positional input device, receiving positional input data from a second positional input device, and scaling the positional input data from the first and the second positional input devices using a common axis therebetween. Scaled positional output data is displayed on a three dimensional display device.

In another embodiment, a method for displaying multiple degree of freedom (DOF) positional input data from a multiple DOF input source includes depicting a three dimensional pointing icon on a three dimensional display device, the three dimensional display device having a first three dimensional coordinate system associated therewith. The positional input data from the multiple DOF input source has a second three dimensional coordinate system associated therewith.

In another embodiment, a system for displaying multiple degree of freedom (DOF) positional input data includes a multiple DOF input source for generating the positional input data, and a three dimensional display device configured to depict a three dimensional pointing icon on the three dimensional display device. The three dimensional display device has a first three dimensional coordinate system associated therewith, wherein the positional input data from the multiple DOF input source has a second three dimensional coordinate system associated therewith.

### BRIEF DESCRIPTION OF THE DRAWINGS

Referring to the exemplary drawings wherein like elements are numbered alike in the several Figures:

FIG. 1 is a block diagram of a system for fusing and displaying multiple degree-of-freedom (DOF) positional input data from multiple input sources, in accordance with an embodiment of the invention;

FIG. 2 is a block diagram of a method for fusing and displaying multiple DOF positional input data from multiple input sources, in accordance with a further embodiment of the invention;

FIG. 3 is a schematic diagram of one possible implementation of the system of FIG. 1, in accordance with a further embodiment of the invention;

FIG. 4 is a flow diagram illustrating a method for fusing multiple DOF positional input data, such as obtained through the system of FIG. 3, in accordance with still a further embodiment of the invention;

FIG. 5 is a perspective view of a spatial display including a coordinate system and three dimensional pointer icon for displaying three dimensional positional input information, in accordance with still another embodiment of the invention;

FIG. 6 is a perspective view of a three dimensional input device that may be used to control the location of a three dimensional pointer, such as shown in FIG. 5;

FIG. 7 illustrates various embodiments of 3-D pointer icons that may be realized in the spatial display shown in FIG. 5;

FIGS. 8(a) through 8(d) are graphical representations of redundant mapping of a 3-D pointer icon to one or more reference grids, in accordance with a further embodiment of the invention;

FIG. 9 illustrates various views of reference planes and angle brackets that may be used to graphically display the location of a 3-D pointer icon, in accordance with a further embodiment of the invention; and

FIG. 10 illustrates various views of angle brackets that may be movingly displayed in conjunction with a 3-D pointer icon, in accordance with still a further embodiment of the invention.

### DETAILED DESCRIPTION

Disclosed herein is a system and method for fusing and displaying multiple degree-of-freedom (DOF) positional input data from multiple input sources, so as to create a human-computer input/display system such as, for example, a three degree-of-freedom (3DOF) input device to be used as a three-dimensional (3-D) positional pointer/cursor for a 3-D display device. The system and method embodiments described hereinafter thus allow for the use of commercial off-the-shelf devices (such as 2-D mouse devices, gyroscopic pointers, touch pads, camera tracking devices, etc.) to provide at least three-dimensional input data.

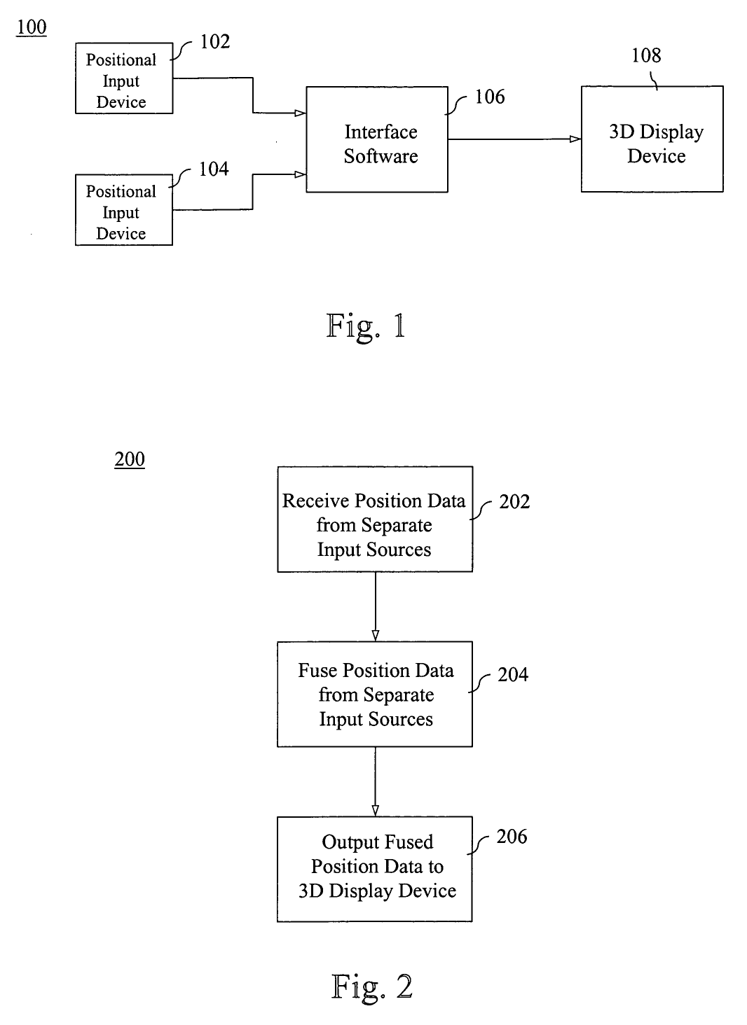

Referring initially to FIG. 1, there is shown a block diagram of a system 100 for fusing and displaying multiple DOF positional input data from multiple input sources, in accordance with an embodiment of the invention. As is shown, the system 100 includes a first positional input device 102 and a second positional input device 104. Suitable examples of the first and second positional input devices 102, 104 may include, but are not limited to, devices such as 2-D mouse devices, gyroscopic pointers, touch pads, camera tracking devices, and the like. In addition, system 100 includes interface software 106 in order to “fuse” the positional input data obtained from the first and second positional input devices 102, 104. Depending on the particular selection of positional input devices and system hardware available, the interface software may be embedded within one or more of the positional input devices, located within a host environment (such as a personal computer or workstation), or even within a display device, such as 3-D display device 108.

FIG. 2 illustrates a method 200 for fusing and displaying multiple DOF positional input data from multiple input sources, in accordance with a further embodiment of the invention. In the embodiment depicted, method 200 is implemented through the use of appropriate interface software, such as interface software 106 shown in FIG. 1. At block 202, position data is received from separate positional input sources. This position data is then fused, as shown in block 204, before being outputted to a 3D display device as shown in block 206. In the case where both input sources provide 2D positional input information, a common axis therebetween is established to provide one of the output dimensions. The other two, “non-common” axes from the separate sources provide the second and third output dimensions. It will be noted that the two non-common axes are orthogonal to one another, as well as to the common axis.

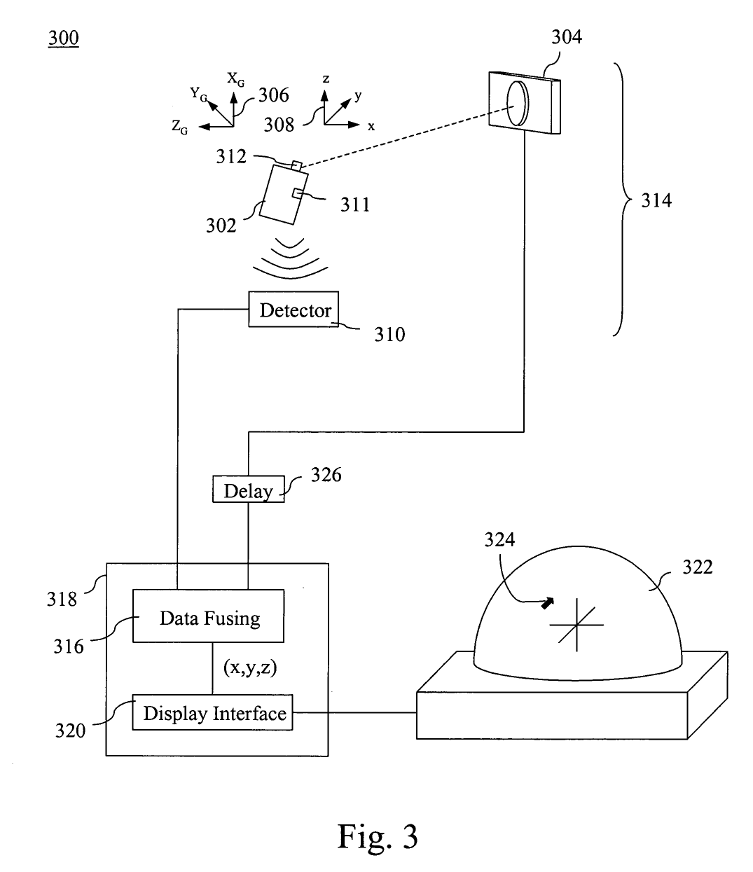

Referring now to FIG. 3, there is shown a schematic diagram 300 of one possible specific implementation of the system of FIG. 1, in accordance with a further embodiment of the invention. As is shown, a hand held gyroscopic pointer 302 is used as a first positional input device, while a camera 304 is used as a second positional input device by tracking the position of the gyroscopic pointer 304. In general, the gyroscopic 2-D pointer 302 converts detected angular accelerations thereof within its own gyroscopic coordinate system 306 (X_{G}, Y_{G}, Z_{G}) into linear displacements of the tip of the gyroscopic 2-D pointer 302 in a world coordinate system 308 (x, y, z). One suitable example of such a gyroscopic 2-D pointer is the GyroMouse Pro™, available from Gyration, Inc. In the embodiment depicted, the gyroscopic pointer 302 is a wireless device, and thus an appropriate wireless detector 310 is used to receive transmitted position data signals from the pointer 302. Moreover, since the 2-D gyroscopic pointer 302 is not inherently self-parkable like a conventional mouse or trackball, a finger-activated clutch 311 is provided so that a user may selectively activate/deactivate the transmission of position data therefrom.

As also shown in FIG. 3, a visually distinct target 312 is affixed to the gyroscopic 2-D pointer 302 so that the position of the pointer 302 may be detected by the camera 304. As indicated previously, a common axis is defined between the position data from 2-D gyroscopic pointer 302 and the position data from 2-D camera 304, while the non-common axis of the camera data is orthogonal to both axes of the gyroscopic 2-D pointer data. Thus configured, the combination of gyroscopic pointer 302 (with wireless detector 310), target 312 and camera 304 collectively define an off-the-shelf, 3DOF pointing device 314.

The positional input data received from the gyroscopic pointer 302 and camera 304 is fused by software 316 included within a host PC 318. Once fused, the resulting 3DOF positional data is converted by a display interface 320 and sent to a three-dimensional display device 322 that may be used, for example, to indicate the position of a volumetric pointer 324 included within the display device 322.

In addition to the data fusing software 316, the system also utilizes processing software for the camera 304 in order to track the target 312 on gyroscopic pointer 302. An example of commercially available tracking software is TrackIR™ (available from NaturalPoint), which uses an infrared light source, retro-reflective targets, and a fast charge coupled device (CCD) array to capture the target(s). Some of the image processing is performed inside the camera itself, while the remaining processing is performed in software included in the host computer (e.g., PC 318). Although the output of the tracking software may represent the absolute position of the target 312, it is more commonly processed so as to behave like a traditional mouse device (i.e., having an incremental output). Finally, a delay element 326 is incorporated into the transmission of the camera position data, as a result of the different latencies between the camera position data and the gyroscopic pointer data. Thus, the delay line 326 synchronizes the position data generated from the two input sources.

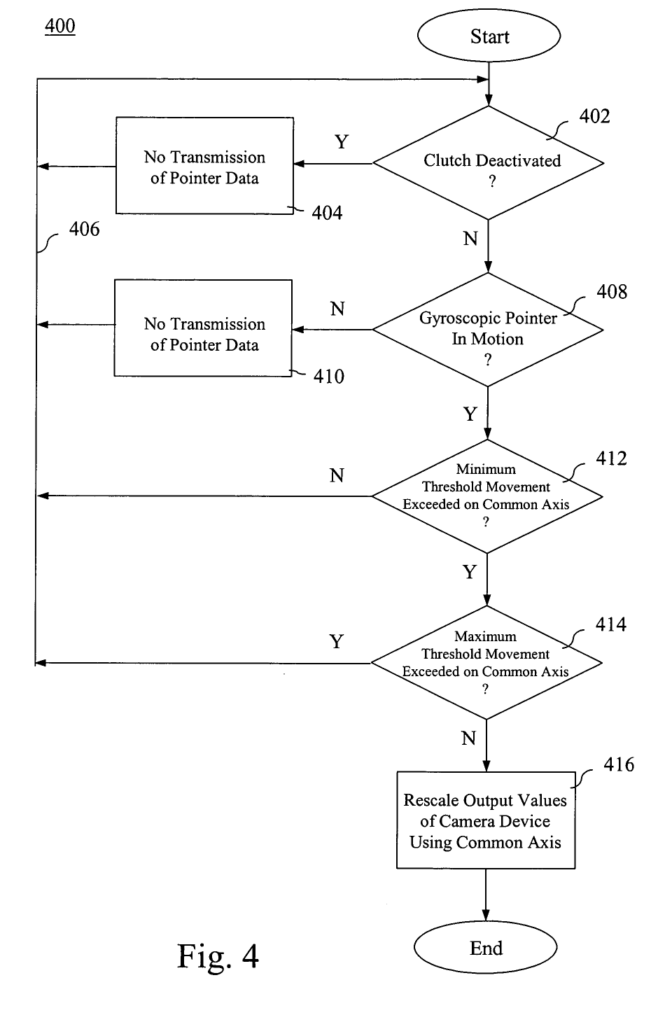

For the particular system embodiment described in FIG. 3, certain specific data fusing processes are implemented, as illustrated in the flow diagram 400 of FIG. 4. For example, because the motion captured by the camera 304 decreases as the target 312 is moved farther away from the camera, a continuous rescaling of the 2-D camera output is ultimately performed using the axis common with the gyroscopic pointer 302, provided certain conditions are satisfied. As shown in decision block 402, it is first determined whether the clutch 311 on the gyroscopic pointer 302 is activated or deactivated, since releasing the clutch 311 thereon terminates the position data transmission. On the other hand, reactivating the clutch 311 resumes the position output data stream as if the gyroscopic pointer 302 were in exactly the same position and orientation as it was when the clutch was disengaged.

Thus, if the clutch is disengaged, there is no transmission of pointer data from the pointer 302, as shown in block 404. In turn, there is no rescaling of the camera output data at this point, and the scaling process begins again through return loop 406. Because the position data transmitted from the camera is output in a continuous manner, it is processed in a manner so as to ignore motion when the clutch is disengaged. This may be accomplished, for example, by accumulating any offsets to each dimension while the clutch is disengaged, and subtracting such offsets while the clutch is engaged.

In addition to the condition of the clutch 311 being disengaged, the gyroscopic pointer 312 will also stop transmitting its position data whenever it is not in motion. Accordingly, decision block 408 checks to see whether the pointer 312 is in motion and, if not, there is no transmission of pointer data from the pointer 302, as shown in block 410. Once again, there is no resealing of the camera output data at this point, and the scaling process begins again through return loop 406. It is further noted that, the camera data may be used by the software to differentiate between these two cases (i.e., clutch disengaged versus no motion of the pointer). Specifically, if the camera 304 detects motion of the pointer 302, and yet the pointer is not transmitting its data, it is concluded that the clutch 311 is disengaged.

Even if there is movement detected within the gyroscopic pointer, decision block 412 inquires as to whether a minimum threshold of motion along the common axis is exceeded, as shown at block 404. This is done in order to prevent quantization errors in the rescaling of the camera data. Thus, if the detected motion along the common axis does not reach the minimum threshold, there is no rescaling of the camera data, and the process returns through return loop 406.

A fast-moving target or a target that moves out of view of the camera may cause the camera data to be dropped or to be momentarily inaccurate. Thus, decision block 414 inquires as to whether a maximum threshold of movement along the common axis motion is exceeded. If so, no resealing takes place. Finally, if all the previously discussed rescaling criteria are satisfied, the process proceeds to block 416 for the rescaling of the output values of the camera data using the common axis.

As will be appreciated, the above described embodiments enable at least a three dimensional human-computer interface (suitable for use with a three dimensional display) that is parkable, relatively inexpensive, flexible and scalable by fusing the data from a first positional input device and a second positional input device. It should be understood that the specific implementations herein are exemplary in nature and that further embodiments and modifications are also contemplated. For instance, an infrared LED may be integrated into the end of the gyroscopic 2-D pointer. Thus configured, the clutch could more directly affect the camera output by also activating the LED with the clutch. This would also better synchronize the outputs of the two devices, while modulation of the LED can improve target recognition. Target recognition may also be improved by elongating the gyroscopic 2-D pointer and improving the accuracy of the camera output.

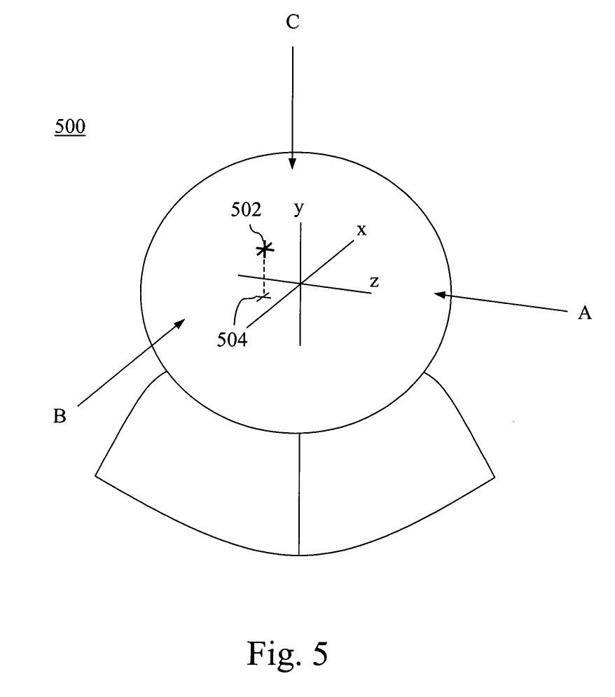

Regardless of whether a multiple degree of freedom input device (e.g., 3DOF or more) is a combination of multiple input devices, or a single integrated input device, the positional input data therefrom may be displayed within a spatial 3-D display device, as indicated previously. For example, FIG. 5 is a perspective view of an exemplary spatial 3-D display 500. For purposes of illustration, three reference viewpoints (A, B, C) are shown, wherein viewpoint “A” corresponds to the gaze direction for a user facing the front of the spatial 3-D display 500. As also shown, 3-D display 500 features a coordinate system (x, y, z), as well as a 3-D pointer icon 502 (particularly depicted in FIG. 5 in the octant where x<0, y>0, and z<0). In addition, a projection 504 of the 3-D pointer icon 502 in the x-z plane is also shown.

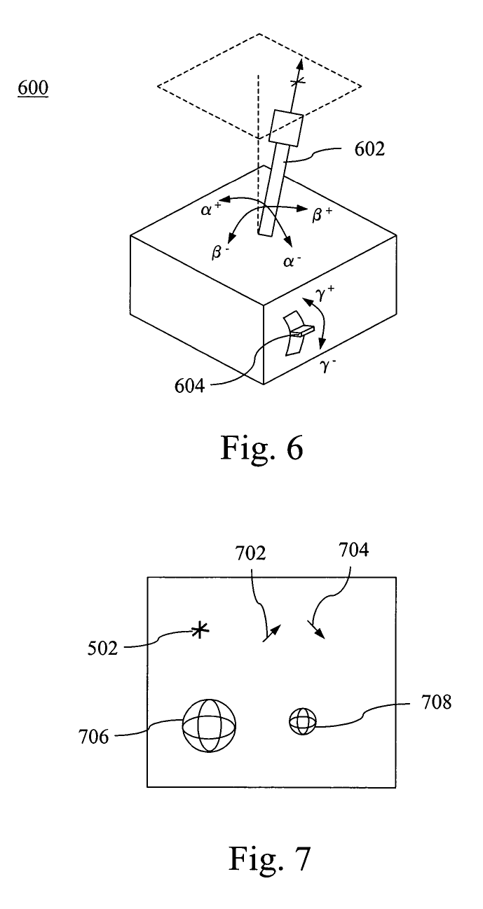

FIG. 6 is a perspective view of a three dimensional input device 600 that may be used to control the location of a three dimensional pointer (e.g., such as pointer icon 502 in FIG. 5). In particular, input device 600 includes a combination 2-D joystick 602 and an up/down slider (lever) 604. In one embodiment, the 2-D joystick 602 may be moved forward and back (along the direction a), as well as moved left and right (along the direction β). Moreover, the slider 604 may be moved up or down along the direction γ. With regard to a spatial 3-D image appearing in the spatial 3-D display (e.g., display 500), a user may gesture at a part of the image by moving the 2-D joystick 602 and the slider 604 accordingly. The positional state of the input device in turn determines the position of the 3-D pointer icon 502 in the spatial 3-D display 500.

In an exemplary embodiment, the mapping from α, β, and γ to the display coordinate directions x, y, and z is arbitrary. For example, movement of the joystick 602 along the positive β direction may cause the 3-D pointer icon 502 to move along the positive x direction, while movement of the joystick 602 along the positive a direction causes movement of the icon 502 along the negative z direction, and movement of the slider 604 in the positive γ direction causes movement of the icon 502 along the positive y direction. Alternatively, the function of α and γ may be swapped, for example, so that movement of the slider 604 causes 3-D pointer icon movement along the z-axis. In still another embodiment, the values of α, β, and γ may influence the pointer position in a combination of x, y, and z. Moreover, since it may also be desirable for the user to set a particular mapping from α, β, and γ to pointer coordinates x, y, and z, a selector switch (not shown) could be provided to selectively swap (for example) the assignment of α and γ to either y or z.

In addition to a crosshair embodiment, the pointer icon 502 may be represented in other forms in a spatial 3-D display, such as an arrow 702, a (user) controlled orientation arrow 704, a sphere 706, and an adjustably sized sphere 708, as shown in FIG. 7. With an adjustably sized sphere, the radius thereof may be controlled by the user or could also be influenced by the imagery in which the 3-D pointer icon is located. For example, as the user reaches a target, the radius of the sphere 708 can change. Although the pointer may be depicted “alone”, it could also be presented with a trail to indicate immediate previous position. The particular length (or duration) of the trail may be a function of time, or of a certain number of pixels.

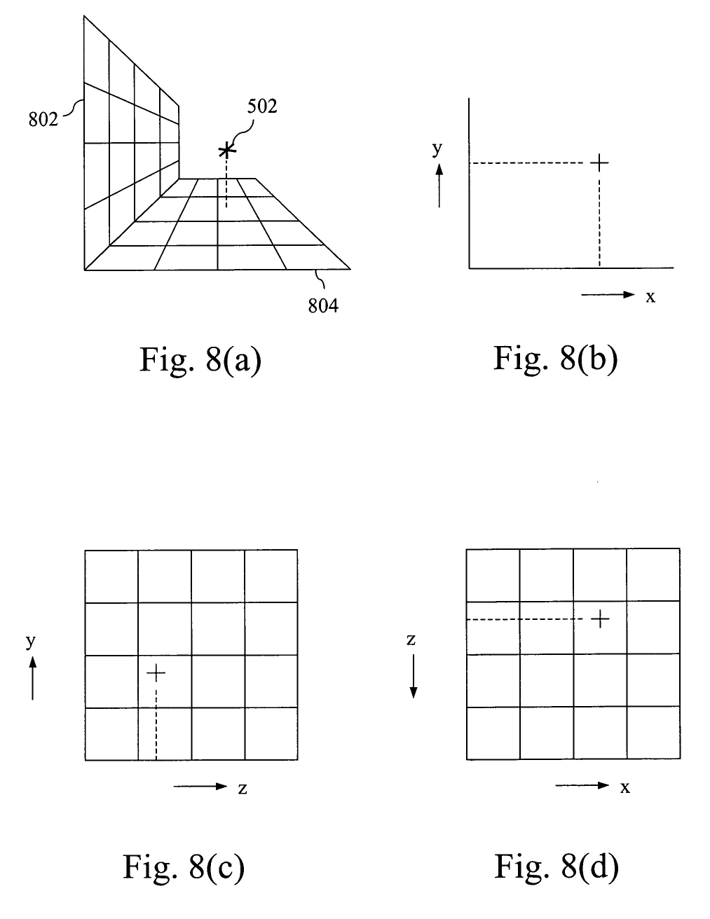

Notwithstanding the particular graphical representation for a 3-D pointer icon, it is further useful to have the position of the 3-D pointer icon be redundantly mapped to other graphical elements. For example, a 3-D pointer icon may be configured to move relative to one, two, three, or more reference grids, which may themselves be stationary or dynamic. FIGS. 8(a) through 8(d) illustrate the position of a 3-D pointer icon 502 with respect to two orthogonal reference grids 802, 804. FIG. 8(a) is a perspective view of the pointer 502 and reference grids 802, 804, while FIGS. 8(b) through 8(d) are views of the pointer and reference grids along viewpoints “A”, “B”, and “C”, respectively (from FIG. 5). Optionally, lines or dotted lines may be cast from the 3-D pointer icon 502 to each reference grid, as particularly shown in FIGS. 8(b) through 8(d).

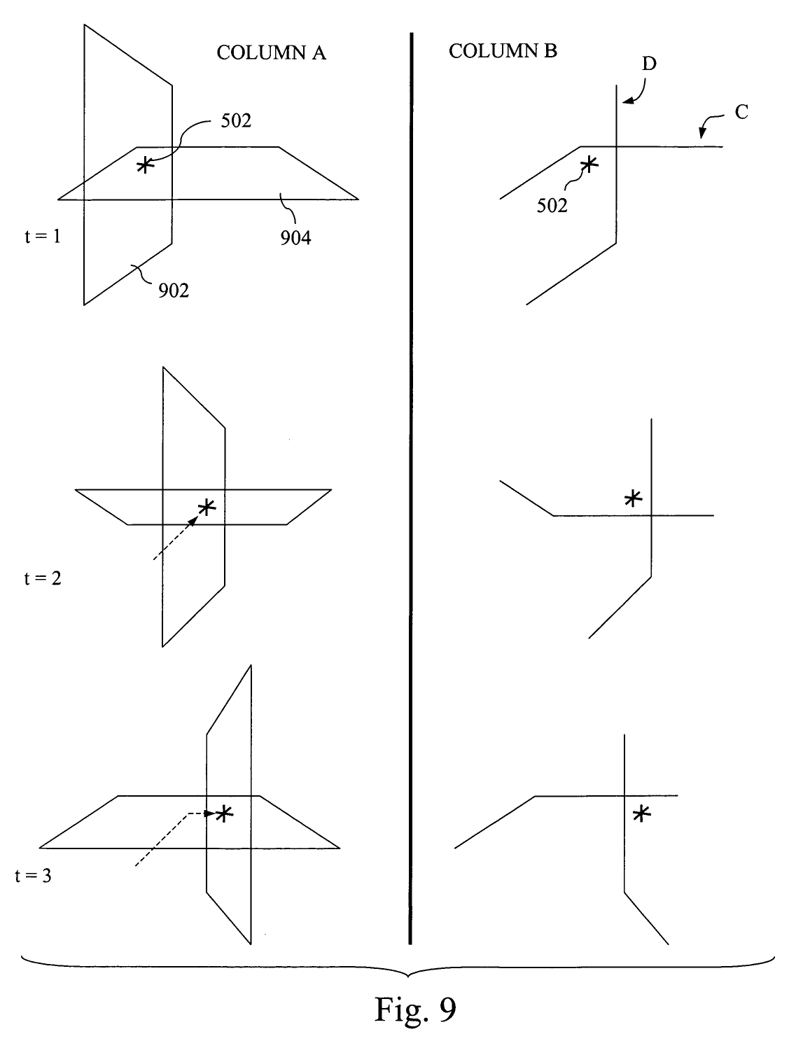

In still another display embodiment, a 3-D spatial visual reference is provided by drawing one, two, three, or more reference structures whose locations are a function of the position of the 3-D pointer icon. Referring now to FIG. 9, there is shown a series of successive movements of a pointer icon 502, in combination with a pair of reference planes 902, 904 (column A) or, alternatively, in combination with a pair of angle brackets “C”, “D” (column B). Regardless of whether the reference structures are reference planes or angle brackets, the movement of the reference planes/angle brackets correspond to the changing position of the pointer icon 502 as it moves from one location to another beginning at time, t=1 through t=3. For example, in the reference angle bracket embodiment in column B, as the icon 502 moves along the y-axis, angle bracket “C” moves up and down in the spatial 3-D display. As the icon 502 moves along the x-axis, angle bracket “D” moves left and right in the spatial 3-D display.

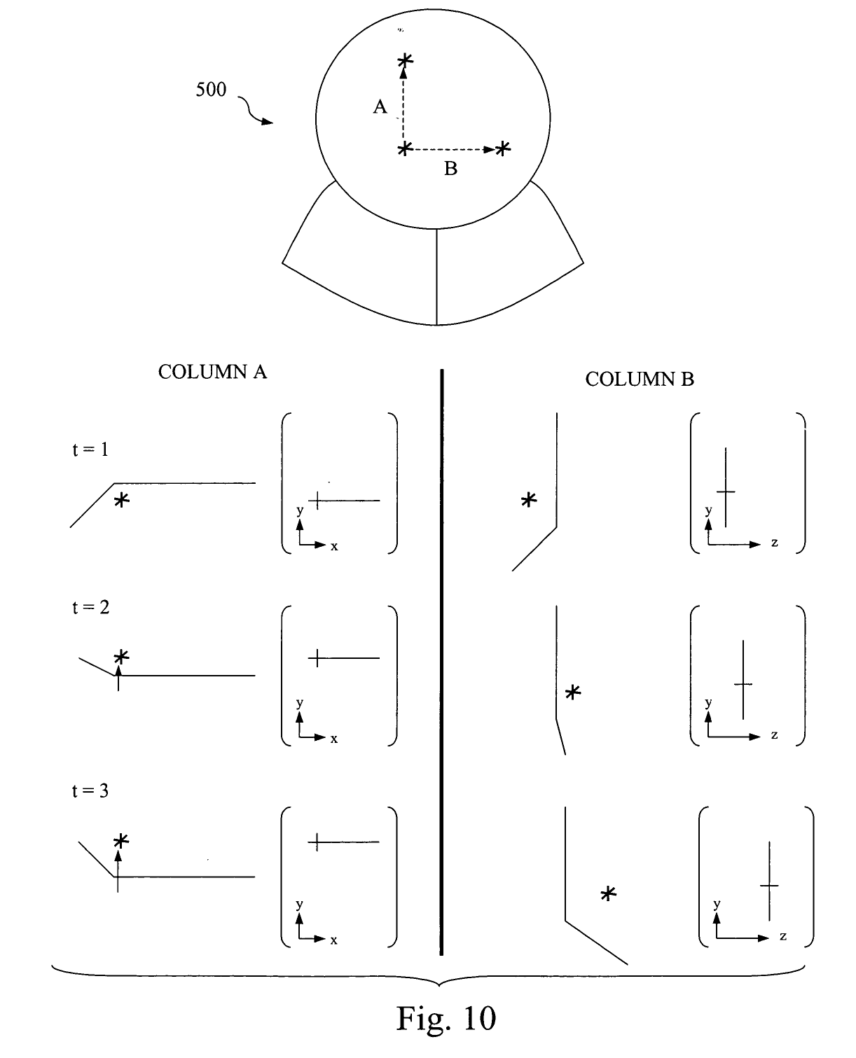

Finally, FIG. 10 illustrates the use of a single angle bracket as the 3-D pointer icon 502 is directed by a user to move along path A (as sequentially depicted in column A) and along path B in the display 500 (as sequentially depicted in column B). In the example illustrated, path A is movement up the y-axis. It will be noted that the legends in parentheses in column A show the movement of path A along two-dimensional viewpoint “A” (from FIG. 5). Thus, as can be seen, when the 3-D pointer icon 502 moves along the y-axis, the angle bracket moves up with it. Similarly, path B represents movement along the z-axis. Accordingly, the legends in parenthesis in column B show the movement of path B along two-dimensional viewpoint “B” (from FIG. 5). Again, as the 3-D pointer icon 502 moves along the z-axis, the angle bracket translates with it.

As will be appreciated, a multiple DOF positional input and display system can have many uses and applications, just as a 2-D mouse pointer has many uses. For example, a 3-D input device can be used to gesture at a region of a 3-D scene as described above. Alternatively, a 3-D input device can be used to control an on-screen/in-screen graphical user interface, such as described in U.S. application Ser. No. 10/688,595, filed Oct. 17, 2003, and assigned to the assignee of the present application, the contents of which are incorporated herein in their entirety.

The multiple DOF system can return physical (i.e., haptic) feedback to the user if a force-feedback joystick is used as an input device therein. For example, an image of clay can appear in the spatial 3-D display, such that when the user directs the 3-D pointer icon to push into the clay, the user will “feel” the resistance of clay in the joystick itself. An example of a suitable force-feedback device in this regard is the SideWinder™ joystick (available from Microsoft) or the Phantom® Haptic interface/force-feedback peripheral device (available from SensAble Technologies).

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Existing systems having reprogrammable storage (e.g., flash memory) can be updated to implement the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for fusing multiple degree of freedom (DOF) positional input data, comprising:
software configured to scale positional output data from a first positional input device and a second positional input device, using a common axis therebetween;
said positional output data from said first positional input device having at least two degrees of freedom associated therewith; and
said positional output data from said second positional input device having at least two degrees of freedom associated therewith.

2. The system of claim 1, wherein:
said common axis defines a first dimension of scaled positional output data from said software;
a non-common axis of said positional output data from said first positional input device defines a second dimension of said scaled positional output data; and
a non-common axis of said positional output data from said second positional input device defines a third dimension of said scaled positional output data.

3. The system of claim 2, wherein:
said non-common axis of said first positional input device is orthogonal to said non-common axis of said second positional input device; and
said non-common axis of said first positional input device and said non-common axis of said second positional input device are orthogonal to said common axis.

4. The system of claim 3, further comprising a three dimensional display configured to display said scaled positional output data from said software.

5. The system of claim 1, wherein said software is embedded in a host environment.

6. The system of claim 1, wherein said software is embedded within at least one of said first positional input device and said second positional input device.

7. A system for fusing and displaying multiple degree of freedom (DOF) positional input data, comprising:
a first positional input device;
a second positional input device configured to track the position of said first positional input device;
software in communication with said first and said second positional input device, said software configured to scale positional output data from said first and said second positional input devices using a common axis therebetween; and
a three dimensional display configured to display scaled positional output data from said software.

8. The system of claim 7, wherein:
said first positional input device has at least two degrees of freedom associated therewith; and
said second positional input device has at least two degrees of freedom associated therewith.

9. The system of claim 8, wherein:
said common axis defines a first dimension of said scaled positional output data;
a non-common axis of said first positional input device defines a second dimension of said scaled positional output data; and
a non-common axis of said second positional input device defines a third dimension of said scaled positional output data.

10. The system of claim 9, wherein:
said non-common axis of said first positional input device is orthogonal to said non-common axis of said second positional input device; and
said non-common axis of said first positional input device and said non-common axis of said second positional input device are orthogonal to said common axis.

11. The system of claim 7, wherein:
said first positional input device further comprises a gyroscopic pointer; and
said second positional input device further comprises a camera configured to track a target attached to said gyroscopic pointer.

12. The system of claim 11, wherein said gyroscopic pointer further comprises a clutch configured for selectively enabling and disabling transmission of positional data generated therefrom.

13. The system of claim 11, further comprising a delay element in communication with said camera, said delay element configured to synchronize positional data generated from said gyroscopic pointer with positional data generated from said gyroscopic pointer.

14. The system of claim 7, wherein said software is configured to prevent scaling of said positional output data from said first and said second positional input devices whenever a minimum threshold of movement along said common axis is not detected.

15. The system of claim 7, wherein said software is configured to prevent scaling of said positional output data from said first and said second positional input devices whenever a maximum threshold of movement along said common axis is detected.

16. The system of claim 7, wherein said software is embedded in a host environment.

17. The system of claim 7, wherein said software is embedded within at least one of said first positional input device and said second positional input device.

18. A method for fusing and displaying multiple degree of freedom (DOF) positional input data from multiple input sources, the method comprising:
receiving positional input data from a first positional input device;
receiving positional input data from a second positional input device;
scaling said positional input data from said first and said second positional input devices using a common axis therebetween; and
displaying scaled positional output data on a three dimensional display device.

19. The method of claim 18, wherein said second positional input device is configured to track the position of said first positional input device.

20. The method of claim 18, further comprising preventing scaling of said positional output data from said first and said second positional input devices whenever a minimum threshold of movement along said common axis is not exceeded.

21. The method of claim 20, further comprising preventing scaling of said positional output data from said first and said second positional input devices whenever a maximum threshold of movement along said common axis is exceeded.

22. The method of claim 21, further comprising preventing scaling of said positional output data from said first and said second positional input devices whenever said receiving positional input data from a first positional input device is interrupted.

23. A storage medium, comprising:
a machine readable computer program code for fusing and displaying multiple degree of freedom (DOF) positional input data from multiple input sources; and
instructions for causing a computer to implement a method, the method further comprising:
receiving positional input data from a first positional input device;
receiving positional input data from a second positional input device;
scaling said positional input data from said first and said second positional input devices using a common axis therebetween; and
displaying scaled positional output data on a three dimensional display device.

24. A method for displaying multiple degree of freedom (DOF) positional input data from a multiple DOF input source, the method comprising:
depicting a three dimensional pointing icon on a three dimensional display device, said three dimensional display device having a first three dimensional coordinate system associated therewith;
wherein the positional input data from the multiple DOF input source has a second three dimensional coordinate system associated therewith.

25. The method of claim 24, wherein said first three dimensional coordinate system is configured to be arbitrarily mapped with respect to said second three dimensional coordinate system.

26. The method of claim 24, wherein said three dimensional pointing icon further comprises at least one of: a crosshair configuration, an arrow configuration, and a spherical configuration.

27. The method of claim 26, wherein said three dimensional pointing icon is adjustably sized spherical configuration.

28. The method of claim 24, further comprising mapping said three dimensional pointing icon to at least one reference grid, said at least one reference grid displayed on said three dimensional display device.

29. The method of claim 24, further comprising tracking at least one reference structure with said three dimensional pointing icon, said at least one reference structure displayed on said three dimensional display device.

30. The method of claim 29, wherein said at least one reference structure comprises a reference plane.

31. The method of claim 29, wherein said at least one reference structure comprises a reference angle bracket.

32. A system for displaying multiple degree of freedom (DOF) positional input data, comprising:
a multiple DOF input source for generating the positional input data;
a three dimensional display device configured to depict a three dimensional pointing icon on said three dimensional display device;
said three dimensional display device having a first three dimensional coordinate system associated therewith; and
wherein the positional input data from said multiple DOF input source has a second three dimensional coordinate system associated therewith.

33. The system of claim 32, wherein said first three dimensional coordinate system is configured to be arbitrarily mapped with respect to said second three dimensional coordinate system.

34. The system of claim 32, wherein said three dimensional pointing icon further comprises at least one of: a crosshair configuration, an arrow configuration, and a spherical configuration.

35. The system of claim 34, wherein said three dimensional pointing icon is an adjustably sized spherical configuration.

36. The system of claim 32, wherein said three dimensional pointing icon is mapped to at least one reference grid, said at least one reference grid displayed on said three dimensional display device.

37. The system of claim 32, wherein at least one reference structure is tracked with said three dimensional pointing icon, said at least one reference structure displayed on said three dimensional display device.

38. The system of claim 37, wherein said at least one reference structure comprises a reference plane.

39. The system of claim 37, wherein said at least one reference structure comprises a reference angle bracket.

40. The system of claim 32, wherein said multiple DOF input further comprises:
a joystick configured to provide positional input data along a first axis and a second axis; and
a lever configured to provide positional input data along a third axis.
